(19) United States
(12) Patent Application Publication
(10) Pub. No.: US 2003/0041719 A1
(43) Pub. Date: Mar. 6, 2003

(54) Guitar nut

(76) Inventor: Charles H. Fisher IV, Coalport, PA (US)

Correspondence Address: JOHN S. HALE C/O GIPPLE & HALE, 6665-A OLD DOMINION DRIVE, McLEAN, VA, 22101, US

(21) Appl. No.: 09/943,225

(22) Filed: Aug. 31, 2001

(51) Int. Cl. G10D 3/06

(52) U.S. Cl. 84/314 N

(57) ABSTRACT

A guitar nut for use on an electric guitar with offset tuning pegs comprising a rigid body with a planar base, a plurality of grooves cut into the top surface of the body, each groove being provided with linear portion and a flared distal cut away portion. A plurality of recesses are cut into the rear wall of the nut body with each recess being adjacent to and below each groove. The flared distal portion of each groove is formed by a curved radius cut into the rear face of the rigid body.

### FIELD OF THE INVENTION

The present invention relates generally to the field of electric guitars and guitar nuts which are mounted thereon and is specifically directed toward a guitar nut for use with an electric guitar with offset tuning pegs.

### BACKGROUND OF THE INVENTION

It has been conventional in electric guitars to stretch the strings over a bridge on the body of the guitar and over a nut located at the junction between the fingerboard on the neck of the guitar and the head which is connected at the end of the neck opposite from the body portion. A plurality of tuning devices in the form of pegs or screws are mounted on the head and are operable by rotation to adjust the tension in the electric guitar strings which extend from the body of the instrument along the neck to the head. The working parts of the strings are located between the bridge and the nut. The nut is the part of the instrument adjacent to the outer edge of the fingerboard near the tension adjusting (tuning) screws. The nut positions the strings relative to the neck and over the frets of the guitar. After passing over the nut which traditionally has notches or grooves cut therein, the strings are connected to tuning pegs or screws located on the head. The base of the nut is configured to provide for a snug fit of the nut with respect to the neck of the guitar.

The manner in which the nut cooperates with the strings is very important in obtaining the desired tone from the guitar. Thus, the nut must be accurately located to determine the effective length of the strings and must hold the strings against side wise movement in order to avoid a buzzing sound effect. During the operation of a tremolo, the nut should allow the tension in the strings to be varied in a predictable manner.

The primary function of the nut has been to suspend the strings of the guitar over the fingerboard and to enable a uniform spacing to be obtained between each of the strings and the frets on the neck of the guitar. Accordingly the crown of the nut is typically provided with small grooves to provide a seat for the supported strings. Presently this positioning factor has been the only design consideration applied toward innovation of the nut in the prior art.

The prior art discloses several examples of guitar nuts used for directing the guitar strings from the neck to the head on qn electric guitar. Prior art guitar nuts have utilized a straight piece of material in which grooves are formed. The grooves in the nut are typically formed with a width and depth corresponding to the diameter of the strings. Also the orientation of the grooves is such that the strings go straight back from a rear edge of the rear face of the nut to the tuning devices on the head of the guitar.

As previously noted, conventional guitar nuts are fixed across the neck of the electric guitar and are provided with grooves cut in the top to engage the strings of the guitar in the manner previously stated. A typical such nut made of alumina ceramics is shown in U.S. Pat. No. 4,308,784.

However when the electric guitar has offset tuning pegs or screws from the axis of the strings along the neck, some guitar nuts are provided with one or more grooves which are angled with respect to the other grooves. This head and tuning construction is quite common with a number of electric guitars, resulting in the strings being angled from the rear face of the nut toward the respective tuning peg to which it is fastened.

One attempt to get around the problems caused by such conventional nuts is found in U.S. Pat. No. 4,206,679 which discloses an electric Spanish guitar incorporating a unitary nut which is fixedly mounted on the neck of the guitar in the same place as a conventional nut. The nut has a plurality of angled string bores drilled there through. Each angled string bore is formed with a plurality of edges offset from each other, the offsets being such that each of the strings bends sharply at two places engaging a wall surface before being secured to a turning screw.

Another attempt to solve the problems in the prior art is shown by U.S. Pat. No. 5,394,783 which is directed toward a plurality of string support assemblies mounted adjacent to a connection between the head and neck portions of the instrument. Each of the string support assemblies includes a pair of spheres which are held in engagement with each other. Each of the strings presses against a pair of different diameter spheres to position the string so that it bends around the larger one of the two spheres. The spheres are disposed in a recess which extends part way through the string support.

U.S. Pat. No. 4,960,027 discloses a bridge for a stringed instrument having a string supporting portion comprising a composition having a first component of rigid material and a second component of lubricating material. Each saddle has an elongated aperture there through with a curved notch at one end for receiving the string which passes over the front end of the saddle and then over the notch.

U.S. Pat. No. 1,599,184 discloses a guitar nut having a curved rear surface which has grooves in the top surface crown to hold the strings of the instrument.

The prior art does not solve the problems which arise when guitar strings are caused to diverge from a linear parallel orientation on the guitar neck and angularly veer to side head tuning pegs on a guitar.

The problem with the prior art electric guitar nuts is that the surface engaging the strings cause kinking, pinching, string bending and wear. Furthermore when a tremolo is used the strings often do not seat back in the string grooves. In addition prior art guitar nuts essentially act as dampeners on the vibration energy of the suspended strings effecting the tonal quality of the instrument.

The guitar nut of the present invention solves these problems and provides the electric guitar user with a convenient, high quality alternative to the prior art guitar nuts which had previously been available.

It is not surprising that those skilled in the art have generally disregarded the nut of the guitar when seeking to improve sound production or playing aspect of the guitar. The present invention solves the above problems in a manner not disclosed in the known prior art.

### SUMMARY OF THE INVENTION

The present invention is directed toward a guitar nut for use on an electric guitar with tuning pegs positioned divergent from the axis of the strings along the neck of the guitar. The guitar nut is constructed with a rigid body having a front face, a rear face, a crown, a planar base and a plurality of grooves cut into the crown of body at a depth to hold and accommodate each string. Each groove is constructed with a linear portion and a flared distal portion formed by a recessed portion cut away on the rear face from the crown to the base. The flared distal portion of the groove is formed with a curved radius on each side with the distal end of the groove ending in a downward curve.

It can thus be seen that a need exists for a guitar nut used on an electric guitar that can be easily manufactured and allows for easy string seating and reseating when a tremolo is used, provides infinite adjustment, has minimal vibration absorption and when used provides a stable platform for the string which is seated thereon.

It is an object of the present invention to provide an improved guitar nut for an electric guitar which provides truer sound quality produced by vibration of the strings.

It is a further object of the invention to provide an improved guitar nut which transfers vibration energy from the supported strings into the neck and body of the instrument.

It is an additional object of the invention to provide an improved guitar nut which can selectively hold and the strings of an electric guitar when the head stock is provided with divergent tuning pegs which cause the strings to diverge from a straight path along the neck of the electric guitar.

It is another object of the invention to provide an improved guitar nut which can eliminate string bending on an electric guitar having a head stock provided with tuning pegs which are located on the side of the head stock causing the strings to diverge from a linear path.

It is another object of the invention to provide an improved guitar nut which can eliminate string pinching on an electric guitar having a head stock provided with tuning pegs which are located on the side of the head stock causing the strings to diverge from a linear path.

It is still another object of the invention to provide an improved guitar nut which can eliminate point stress on the strings of a guitar having a head stock provided with tuning pegs which are located on the side of the head stock causing the strings to diverge from a linear path.

In the accompanying drawings, there is shown an illustrative embodiment of the invention from which these and other objectives, novel features and advantages will be readily apparent.

### BRIEF DESCRIPTION OF THE DRAWINGS

FIG. 1 is a perspective view of an electric guitar using the inventive nut device;

FIG. 2 is an enlarged sectional perspective view of the inventive guitar nut mounted on the guitar shown in FIG. 2;

FIG. 3 is an enlarged top plan view of the guitar nut shown in FIG. 1;

FIG. 4 is an enlarged side elevational view of the rear face of the guitar nut shown in FIG. 3;

FIG. 5 is an enlarged side elevational view of the front face of the guitar nut shown in FIG. 3;

FIG. 6 is a top plan view of a prior art guitar nut; and

FIG. 7 is a side elevational view of a prior art guitar nut shown in FIG. 6.

### DETAILED DESCRIPTION OF THE PREFERRED EMBODIMENT

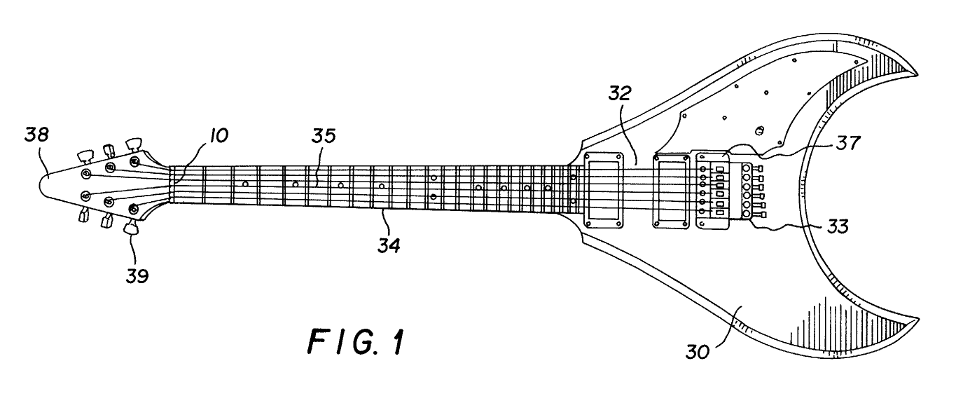

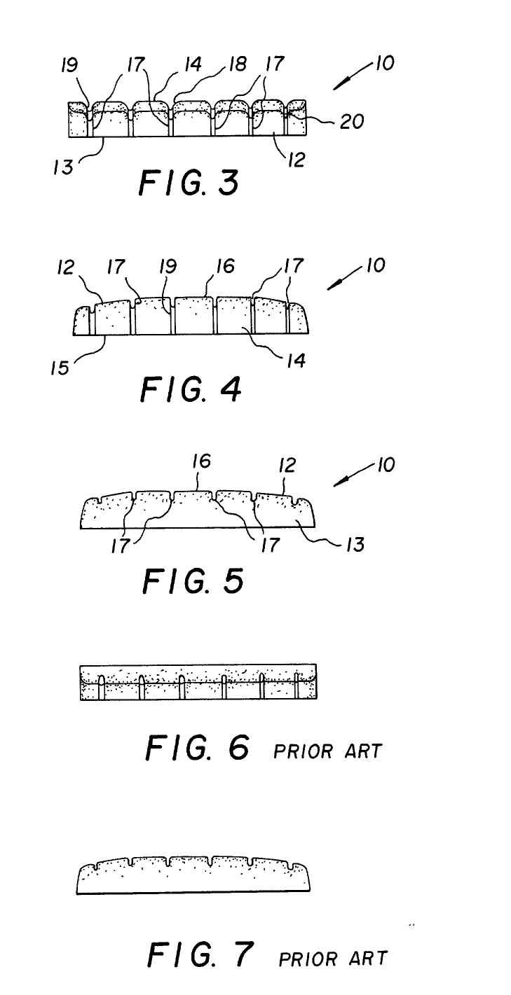

The best mode and the preferred embodiment of the novel guitar nut of the present invention is shown generally in FIGS. 1 through 5.

FIG. 1 illustrates the guitar nut 10 mounted on a six string electric guitar 30. The nut can be mounted onto the guitar by adhesives or by the use of slots which is well known in the art. Representative but not limiting types of adhesives which may be used to secure the guitar nut 10 to the neck 34 include phenol-aldehyde, phenol-urea, epoxy, vinyl acetate, vinyl-acetate butyrate, alpha cyanoacrylates, rubber adhesives and any other adhesive known to be water resistant. The electric guitar 30 has a flat solid wood or plastic body or sounding board 32 from which extends an elongated neck 34, the upper surface of which forms a fingerboard 35 having a plurality of frets 36 mounted thereon and spaced from each other. The frets 36 are located below a set of strings 40 and positioned perpendicular to the strings 40. The outer end of the elongated neck is formed with a head 38 which holds the tuning pegs or screws 39. Six strings are anchored in the guitar body at a region on the opposite side of a bridge 33 as is well known in the art and pass over the neck 34 and guitar nut 10. The strings 40 are fastened to the tuning screws 39 mounted in the head 38. These tuning screws 39 are operable to adjust the tension in the strings 40 in a known manner. A tremolo 37 is generally provided in the body portion of the electric guitar to vary the tension in the strings 40 in a known manner.

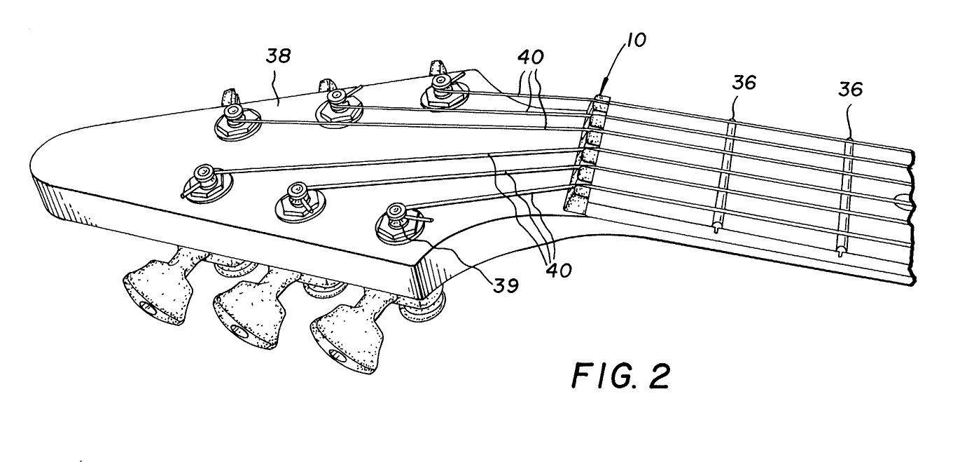

The guitar nut 10 in combination with the bridge 33, supports the plurality of strings 40 above the fingerboard 35. The strings 40 are metal strings of differing diameters having magnetizable cores which disturb the fields of electromagnetic transducers (pickups) and when the string vibrations are sensed by the transducers, the resulting currents are amplified electronically and then transmitted to loudspeaker means (not shown). The guitar nut 10 holds the strings 40 of the electric guitar 30 in a spaced relationship and once past the guitar nut 10 the strings 40 angularly diverge from the linear parallel position they maintained on the guitar neck 34 to the head 38 where they are held by tuning pegs 39 mounted on each side of the head 38 of the electric guitar as is shown in FIGS. 1 and 2. The nut 10 is positioned adjacent the upper neck portion in combination with the bridge 33 aligns and supports the strings 40 spaced above the neck fingerboard 35 against which they are pressed during playing of the guitar 30.

The guitar nut 10 has a one piece integral formed body 12 with a front face 13 for placement adjacent to the fingerboard 35, a back face 14, a planar base 15 adapted to be fastened across the guitar stem to have a snug fit with respect to the neck and fingerboard of the guitar and a crown 16. If desired the back face 14 can be substantially perpendicular to the planar base 15 or can be inclined forming an acute angle with the base. The guitar nut 10 can be constructed of metal such as brass or stainless steel but is preferably constructed of graphite, silicone or plastic such as polycarbonate resin or acetal resins with a preferred composition of RYTON, a trademarked product of the Phillips Chemical Co.. Alternatively the nut may be constructed with material according to the teaching of U.S. Pat. No. 4,960,027 which is incorporated herein by reference. The body 12 has a length preferably running from 1⅝ inches to 1¾ inches and a width ranging from 3/16 inch to ¼ inch. The height of the nut body 12 varies but must be sufficient to permit the strings 40 to ride above the frets 36 when the instrument is in tune. Typically the height of the guitar nut 10 is between 1/16 inch and ¼ inch and preferably in the order of ⅛ inch. A plurality of string grooves 17 are cut across the crown 16 between ½ the diameter of the specific string to 1½ the diameter of the specific string deep to accommodate the different sized strings 40. The string grooves 17 can have a U shaped cross section or a V shaped cross section or an angular cross section. Furthermore the string grooves 17 can be of the same width or different widths to accommodate the different sized strings. The string grooves 17 ensure that the taut string remains seated in its proper position and when a tremolo is used allows the loosened strings 40 to easily return to their respective grooves. Each groove is flared 18 at its distal end (nearest the head) or rear face 14 with a curved round over forming a radius of about 3/32 inch. The distal end of the groove 17 and rear face 14 is also troughed out or removed from back face to form a recess 19 from the crown to the base of the nut. The recess 19 is cut back into the depth or width of the nut from the rear face about ⅛ inch or from 30% to 60% of the width of the nut with the edges of the recess 19 being curved to match the curved flared portion 18 so that the string groove 17 as measured from the front face 13 to the recess of the rear face 14 has a length from 70% to 40% of the width of the nut. If desired the groove's distal end surface 20 adjacent and leading to the recess 19 can be rounded to eliminate any sharp edges which may affect the string 40 held therein.

While the preferred embodiment of the guitar nut uses a substantially linear body with a truncated trapezoidal cross section other geometric shaped bodies could be used.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A guitar nut for an electric guitar comprising:
a rigid body with a base, a plurality of grooves cut into the top surface of said body, said body being provided with a distal cut away portion extending below a bottom surface of each groove, the distal portion of each groove being formed with a curved flare out.

2. A guitar nut as claimed in claim 1 wherein said groove has linear walls which run from about 40% to about 70% of the width of said body.

3. A guitar nut as claimed in claim 1 wherein a recess which intersects said groove is cut down to the base of said nut.

4. A guitar nut as claimed in claim 1 wherein said base is planar.

5. A guitar nut as claimed in claim 4 wherein said flare out is in the form of an arcuate cut out portion.

6. A guitar nut as claimed in claim 1 wherein said body is constructed of a plastic taken from a group consisting of polycarbonate resin and acetal resin coated with a lubricant material.

7. A guitar nut for use on an electric guitar with divergent tuning pegs comprising:
a rigid body with a planar base, a front face, a rear face and a crown, a plurality of grooves cut into the top surface of said crown, each groove being provided with linear portion and a flared distal cut away portion cut into said distal portion of said body and the flared distal portion of said groove being formed with a curved radius on each side and a recess cut into said rear face from about 30% to about 70% of the width of said rigid body, said recess running from said crown to said base.

8. A guitar nut as claimed in claim 7 wherein said rear face of said body is substantially perpendicular to a plane formed by said planar base.

9. A guitar nut as claimed in claim 8 wherein said rear face of said body is inclined from a plane formed by said planar base

10. A guitar nut as claimed in claim 7 wherein said groove has a curved base at its distal end adjacent said rear face.

11. A guitar nut as claimed in claim 7 wherein body is constructed of a plastic taken from a group consisting of polycarbonate resin and acetal resin coated with a lubricant material.

12. A guitar nut as claimed in claim 7 wherein said body is constructed of graphite.

13. A guitar nut as claimed in claim 7 wherein said body is constructed of silicone.

14. A guitar nut as claimed in claim 7 wherein said body is constructed of metal.

15. A guitar nut as claimed in claim 7 wherein each said groove has a U shaped cross section.

16. A guitar nut as claimed in claim 11 wherein said grooves are of different widths and depths.

17. A stringed electrical musical instrument with tuning pegs axially offset from the path of the strings over the neck portion of the instrument comprising:
a head portion with tuning pegs, a neck having a fingerboard ending at said head portion and a body portion, a nut located at one end of said neck adjacent said head, an anchor tail piece on the body portion and a bridge on said body portion between said tail piece and the other end of the neck, a plurality of strings extending between the tuning pegs and the tail piece and over the nut and bridge;
said nut comprising a rigid body with a front face, a rear face, a planar base and a crown, a plurality of grooves cut into the top surface of said crown, each groove being formed with a linear portion and a flared distal cut away portion, the flared distal portion of said groove being formed by a curved radius on the rear face of said body communicating with a distal portion of the groove with the distal end of said groove nearest said rear face ending in a curved surface.

18. A stringed electrical musical instrument as claimed in claim 17 wherein each cut away portion is formed by an arcuate opposing portions cut in said rear face.

19. A stringed electrical musical instrument as claimed in claim 17 wherein said grooves have different widths and depths.

20. A stringed electrical musical instrument as claimed in claim 17 wherein each of said grooves has linear walls which run from about 40% to about 70% of the width of said body.

21. A stringed electrical musical instrument as claimed in claim 17 wherein a recess which intersects said groove is into said rear face down to the base of said nut.
